(19) United States
(12) Patent Application Publication
(10) Pub. No.: US 2015/0066661 A1
(43) Pub. Date: Mar. 5, 2015

(54) SYSTEM FOR SCALABLE KEYWORD BID OPTIMIZATION

(71) Applicant: Rohan Bhattacharjee, Redmond, WA (US)

(72) Inventor: Rohan Bhattacharjee, Redmond, WA (US)

(21) Appl. No.: 14/473,684

(22) Filed: Aug. 29, 2014

Related U.S. Application Data
(60) Provisional application No. 61/872,375, filed on Aug. 30, 2013.

(51) Int. Cl. G06Q 30/02

(52) U.S. Cl. CPC G06Q 30/0275
USPC 705/14.71

(57) ABSTRACT

A system and method of providing highly scalable optimization of keyword bids are disclosed. In some embodiments, for each keyword in a plurality of keywords associated with a user, an initialization operation can be performed to initialize a corresponding bid for the keyword at a corresponding initialization value using a cluster of nodes. Each node in the cluster of nodes can correspond to a different keyword in the plurality of keywords. The corresponding bids for the keywords can be initialized in parallel by the cluster of nodes. For each keyword in the plurality of keywords, an update operation can be performed to update the corresponding bid for the keyword to a corresponding updated value different from the corresponding initialization value using the cluster of nodes. The corresponding bids can be updated in parallel by the cluster of nodes.

### CROSS-REFERENCE TO RELATED APPLICATIONS

This application claims priority to U.S. Provisional Application No. 61/872,375, filed on Aug. 30, 2013, entitled, “KEYWORD BID OPTIMIZATION FOR TEXT ADS,” which is hereby incorporated by reference in its entirety as if set forth herein.

### TECHNICAL FIELD

The present application relates generally to the technical field of data processing, and, in various embodiments, to systems and methods of providing highly scalable optimization of calculating values.

### BACKGROUND

When determining keyword bids for their portfolios, organizations, entities, and other users are currently limited by inefficient solutions. Such solutions are hindered by a focus on prediction accuracy rather than result optimization, in addition to suffering from a lack of scalability to accommodate a large portfolio of keywords.

### BRIEF DESCRIPTION OF THE DRAWINGS

Some example embodiments of the present disclosure are illustrated by way of example and not limitation in the figures of the accompanying drawings, in which like reference numbers indicate similar elements, and in which:

FIG. 1 is a block diagram depicting a network architecture of a system having a client-server architecture configured for exchanging data over a network, in accordance with some example embodiments;

FIG. 2 is a block diagram depicting various components of a network-based publication system, in accordance with some example embodiments;

FIG. 3 is a block diagram depicting various tables that can be maintained within a database, in accordance with some example embodiments;

FIG. 4 is a block diagram illustrating interactions of a bid optimization system, in accordance with some example embodiments;

FIG. 5 is a flowchart illustrating a method of optimizing keyword bids, in accordance with some example embodiments;

FIG. 6 is a block diagram illustrating components of a bid optimization system, in accordance with some example embodiments;

FIG. 7 is a flowchart illustrating a method of optimizing keyword bids, in accordance with some example embodiments; and

FIG. 8 shows a diagrammatic representation of a machine in the example form of a computer system within which a set of instructions can be executed to cause the machine to perform any one or more of the methodologies discussed herein, in accordance with some example embodiments.

### DETAILED DESCRIPTION

The description that follows includes illustrative systems, methods, techniques, instruction sequences, and computing machine program products that embody illustrative embodiments. In the following description, for purposes of explanation, numerous specific details are set forth in order to provide an understanding of various embodiments of the inventive subject matter. It will be evident, however, to those skilled in the art that embodiments of the inventive subject matter can be practiced without these specific details. In general, well-known instruction instances, protocols, structures, and techniques have not been shown in detail.

The present disclosure describes systems and methods of keyword bid optimization. In some embodiments, a tight feedback cycle is employed, using greedy algorithm techniques and parallel processing to update bids for a keyword portfolio. The performance of every keyword in the portfolio can be measured and monitored, and then bid values and other aspects of a user's acquisition of keywords on a search engine (e.g., landing page selections) can be tuned for optimal performance.

In some example embodiments, for each keyword in a plurality of keywords associated with a user, an initialization operation can be performed to initialize a corresponding bid for the keyword at a corresponding initialization value using a cluster of nodes. Each node in the cluster of nodes can correspond to a different keyword in the plurality of keywords. The corresponding bids for the keywords can be initialized in parallel by the cluster of nodes. For each keyword in the plurality of keywords, an update operation can be performed to update the corresponding bid for the keyword to a corresponding updated value different from the corresponding initialization value using the cluster of nodes. The corresponding bid can be updated based on at least one greedy algorithm rule. The corresponding bids can be updated in parallel by the cluster of nodes. A spend estimate calculation operation can be performed to calculate a spend estimate of the plurality of keywords based on the corresponding updated values of the keywords. A difference calculation operation can be performed to calculate a difference between the calculated spend estimate and a predetermined budget.

In some example embodiments, the initialization operation, the update operation, the spend estimate calculation operation, and the difference calculation operation can be repeated based on a determination that the difference between the calculated spend estimate and the predetermined budget is greater than a predetermined threshold. The updated values can be transmitted to at least one search engine as bids for their corresponding keywords based on a determination that the difference between the calculated spend estimate and a predetermined budget is less than a predetermined threshold.

In some example embodiments, the update operation can comprise increasing the corresponding bid for at least one keyword of the plurality of keywords by a first value based on a profit determination for the at least one keyword, with the profit determination comprising a determination that the keyword(s) meets a predetermined threshold of profitability, and increasing the corresponding bid for the keyword(s) by a second value based on an exposure determination for the at least one keyword, with the exposure determination comprising a determination to increase a level of exposure for published content of the user. The level of exposure can correspond to searches of the keyword(s) on a search engine. The user can be enabled to configure the first value and the second value (e.g., via a user interface).

In some example embodiments, the exposure determination can be based on a determination that a ratio of a number of impressions for the published content on the search engine to a total search volume on the search engine for a specified period of time is less than a predetermined value. The exposure determination can be based on a determination that a click-through rate for the at least one keyword on the search engine is a predetermined amount greater than a click-through rate for a population of keywords on the search engine. The exposure determination can be based on a determination that a predetermined amount of inventory on an online marketplace of the user has a predetermined level of affinity with the at least one keyword. The exposure determination can be based on a determination that a period-based budget of the user has increased by at least a predetermined amount.

In some example embodiments, the update operation can comprise adjusting the corresponding bid for at least one keyword of the plurality of keywords based on an external suggestion from an application programming interface (API) of a search engine.

The methods or embodiments disclosed herein can be implemented as a computer system having one or more modules (e.g., hardware modules or software modules). Such modules can be executed by one or more processors of the computer system. The methods or embodiments disclosed herein can be embodied as instructions stored on a machine-readable medium that, when executed by one or more processors, cause the one or more processors to perform the instructions.

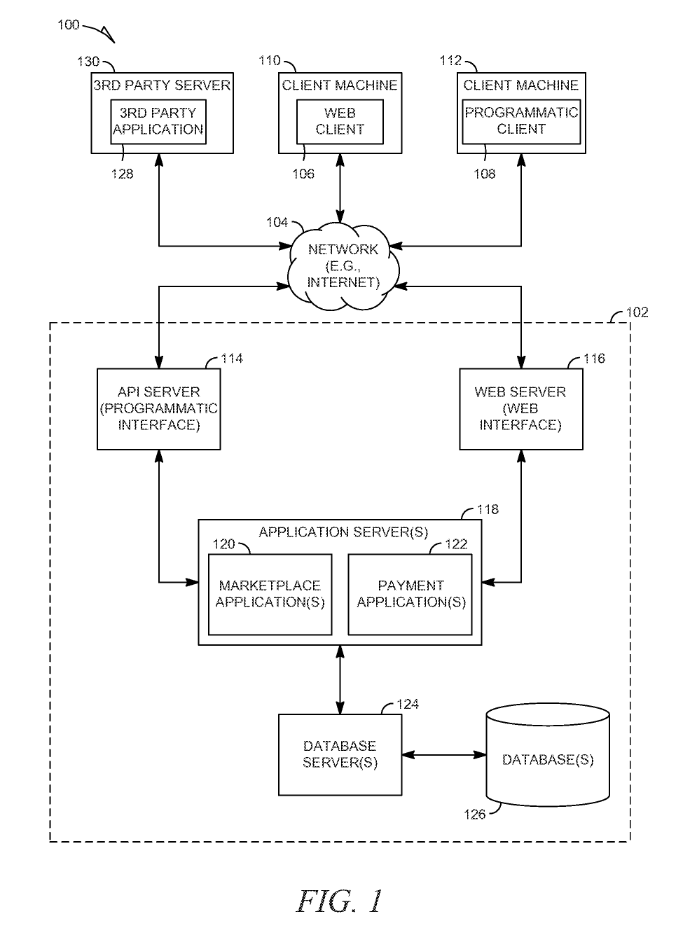

FIG. 1 is a network diagram depicting a client-server system 100, within which one example embodiment can be deployed. A networked system 102, in the example forms of a network-based marketplace or publication system, provides server-side functionality, via a network 104 (e.g., the Internet or a Wide Area Network (WAN)) to one or more clients. FIG. 1 illustrates, for example, a web client 106 (e.g., a browser, such as the Internet Explorer browser developed by Microsoft Corporation of Redmond, Wash. State) and a programmatic client 108 executing on respective client machines 110 and 112. Client machines 110 and 112 can comprise computing devices (e.g., desktop computers, laptop computers, tablet computers, smartphones, wearable devices, and other mobile devices).

An API server 114 and a web server 116 are coupled to, and provide programmatic and web interfaces respectively to, one or more application servers 118. The application servers 118 host one or more marketplace applications 120 and payment applications 122. The application servers 118 are, in turn, shown to be coupled to one or more database servers 124 that facilitate access to one or more databases 126.

The marketplace applications 120 can provide a number of marketplace functions and services to users who access the networked system 102. The payment applications 122 can likewise provide a number of payment services and functions to users. The payment applications 122 can allow users to accumulate value (e.g., in a commercial currency, such as the U.S. dollar, or a proprietary currency, such as “points”) in accounts, and then later to redeem the accumulated value for products (e.g., goods or services) that are made available via the marketplace applications 120. While the marketplace and payment applications 120 and 122 are shown in FIG. 1 to both form part of the networked system 102, it will be appreciated that, in alternative embodiments, the payment applications 122 can form part of a payment service that is separate and distinct from the networked system 102.

Further, while the client-server system 100 shown in FIG. 1 employs a client-server architecture, the embodiments are, of course not limited to such an architecture, and can equally well find application in a distributed, or peer-to-peer, architecture system, for example. The various marketplace and payment applications 120 and 122 could also be implemented as standalone software programs, which do not necessarily have networking capabilities.

The web client 106 accesses the various marketplace and payment applications 120 and 122 via the web interface supported by the web server 116. Similarly, the programmatic client 108 accesses the various services and functions provided by the marketplace and payment applications 120 and 122 via the programmatic interface provided by the API server 114. The programmatic client 108 can, for example, be a seller application (e.g., the TurboLister application developed by eBay Inc., of San Jose, Calif.) to enable sellers to author and manage listings on the networked system 102 in an off-line manner, and to perform batch-mode communications between the programmatic client 108 and the networked system 102.

FIG. 1 also illustrates a third party application 128, executing on a third party server machine 130, as having programmatic access to the networked system 102 via the programmatic interface provided by the API server 114. For example, the third party application 128 can, utilizing information retrieved from the networked system 102, support one or more features or functions on a website hosted by the third party. The third party website can, for example, provide one or more promotional, marketplace, or payment functions that are supported by the relevant applications of the networked system 102.

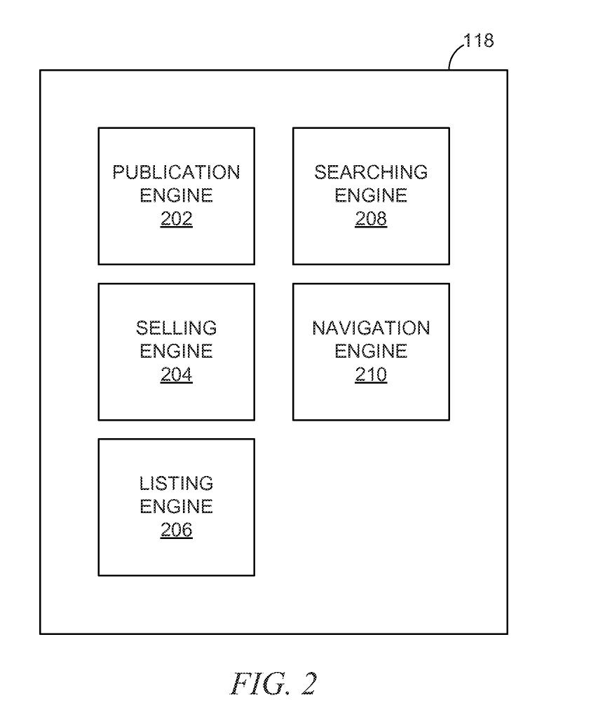

FIG. 2 illustrates a block diagram showing components provided within the application server(s) 118, according to some embodiments. The components of the application server(s) 118 can be hosted on dedicated or shared server machines (not shown) that are communicatively coupled to enable communications between the server machines. The components themselves are communicatively coupled (e.g., via appropriate interfaces) to each other and to various data sources, so as to allow information to be passed between the applications or so as to allow the applications to share and access common data. Furthermore, the components can access one or more databases 126 via the database servers 124.

The application server(s) 118 can provide a number of publishing, listing, and/or price-setting mechanisms whereby a seller (also referred to as a “first user”) can list (or publish information concerning) goods or services for sale or barter, a buyer (also referred to as a “second user”) can express interest in or indicate a desire to purchase or barter such goods or services, and a transaction (such as a trade) can be completed pertaining to the goods or services. To this end, the application server(s) 118 can comprise at least one publication engine 202 and one or more selling engines 204. The publication engine 202 can publish information, such as item listings or product description pages, on the networked system 102. In some embodiments, the selling engines 204 can comprise one or more fixed-price engines that support fixed-price listing and price setting mechanisms, and one or more auction engines that support auction-format listing and price setting mechanisms (e.g., English, Dutch, Chinese, Double, Reverse auctions). The various auction engines can also provide a number of features in support of these auction-format listings, such as a reserve price feature whereby a seller can specify a reserve price in connection with a listing, and a proxy-bidding feature whereby a bidder can invoke automated proxy bidding. The selling engines 204 can further comprise one or more deal engines that support merchant-generated offers for products and services.

A listing engine 206 allows sellers to conveniently author listings of items or authors to author publications. In one embodiment, the listings pertain to goods or services that a user (e.g., a seller) wishes to transact via the networked system 102. In some embodiments, the listings can be an offer, deal, coupon, or discount for the good or service. Each good or service is associated with a particular category. The listing engine 206 can receive listing data such as title, description, and aspect name/value pairs. Furthermore, each listing for a good or service can be assigned an item identifier. In other embodiments, a user can create a listing that is an advertisement or other form of information publication. The listing information can then be stored to one or more storage devices coupled to the application server(s) 118 (e.g., databases 126). Listings also can comprise product description pages that display a product and information (e.g., product title, specifications, and reviews) associated with the product. In some embodiments, the product description page can include an aggregation of item listings that correspond to the product described on the product description page.

The listing engine 206 can also allow buyers to conveniently author listings or requests for items desired to be purchased. In some embodiments, the listings can pertain to goods or services that a user (e.g., a buyer) wishes to transact via the application server(s) 118. Each good or service is associated with a particular category. The listing engine 206 can receive as much or as little listing data, such as title, description, and aspect name/value pairs, that the buyer is aware of about the requested item. In some embodiments, the listing engine 206 can parse the buyer's submitted item information and can complete incomplete portions of the listing. For example, if the buyer provides a brief description of a requested item, the listing engine 206 can parse the description, extract key terms, and use those terms to make a determination of the identity of the item. Using the determined item identity, the listing engine 206 can retrieve additional item details for inclusion in the buyer item request. In some embodiments, the listing engine 206 can assign an item identifier to each listing for a good or service.

In some embodiments, the listing engine 206 allows sellers to generate offers for discounts on products or services. The listing engine 206 can receive listing data, such as the product or service being offered, a price and/or discount for the product or service, a time period for which the offer is valid, and so forth. In some embodiments, the listing engine 206 permits sellers to generate offers from the sellers' mobile devices. The generated offers can be uploaded to the networked system 102 for storage and tracking.

Searching the networked system 102 is facilitated by a searching engine 208. For example, the searching engine 208 enables keyword queries of listings published via the networked system 102. In example embodiments, the searching engine 208 receives the keyword queries from a device of a user and conducts a review of the storage device storing the listing information. The review will enable compilation of a result set of listings that can be sorted and returned to the client device (e.g., client machine 110, 112) of the user. The searching engine 208 can record the query (e.g., keywords) and any subsequent user actions and behaviors (e.g., navigations).

The searching engine 208 also can perform a search based on the location of the user. A user can access the searching engine 208 via a mobile device and generate a search query. Using the search query and the user's location, the searching engine 208 can return relevant search results for products, services, offers, auctions, and so forth to the user. The searching engine 208 can identify relevant search results both in a list form and graphically on a map. Selection of a graphical indicator on the map can provide additional details regarding the selected search result. In some embodiments, the user can specify as part of the search query a radius or distance from the user's current location to limit search results.

The searching engine 208 also can perform a search based on an image. The image can be taken from a camera or imaging component of a client device or can be accessed from storage.

In a further example, a navigation engine 210 allows users to navigate through various categories, catalogs, or inventory data structures according to which listings can be classified within the networked system 102. For example, the navigation engine 210 allows a user to successively navigate down a category tree comprising a hierarchy of categories (e.g., the category tree structure) until a particular set of listings is reached. Various other navigation applications within the navigation engine 210 can be provided to supplement the searching and browsing applications. The navigation engine 210 can record the various user actions (e.g., clicks) performed by the user in order to navigate down the category tree.

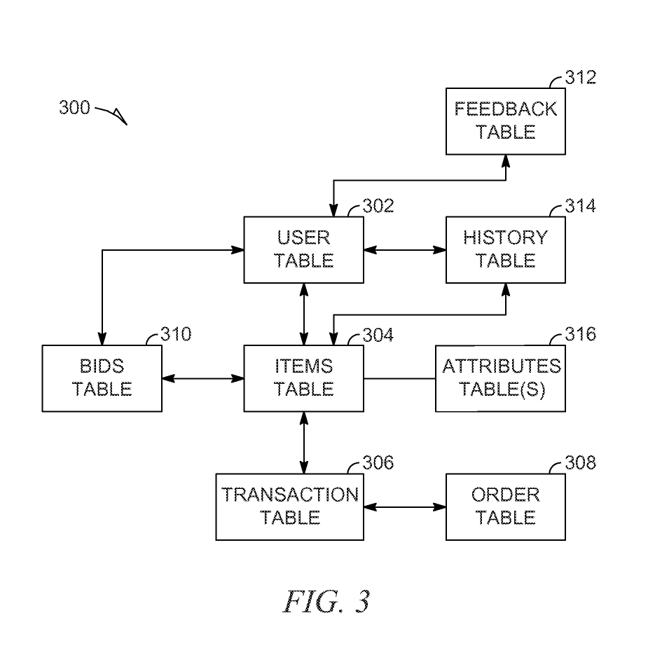

FIG. 3 is a high-level entity-relationship diagram, illustrating various tables 300 that can be maintained within the database(s) 126, and that are utilized by and support the applications 120 and 122. A user table 302 contains a record for each registered user of the networked system 102, and can include identifier, address, and financial instrument information pertaining to each such registered user. A user can operate as a seller, a buyer, or both, within the networked system 102. In one example embodiment, a buyer can be a user that has accumulated value (e.g., commercial or proprietary currency) and is accordingly able to exchange the accumulated value for items that are offered for sale by the networked system 102.

The tables 300 also include an items table 304 in which are maintained item records for goods and services that are available to be, or have been, transacted via the networked system 102. Each item record within the items table 304 can further be linked to one or more user records within the user table 302, so as to associate a seller and one or more actual or potential buyers with each item record.

A transaction table 306 contains a record for each transaction (e.g., a purchase or sale transaction) pertaining to items for which records exist within the items table 304.

An order table 308 is populated with order records, with each order record being associated with an order. Each order, in turn, can be associated with one or more transactions for which records exist within the transaction table 306.

Bid records within a bids table 310 each relate to a bid received at the networked system 102 in connection with an auction-format listing supported by an auction application. A feedback table 312 is utilized by one or more reputation applications, in one example embodiment, to construct and maintain reputation information concerning users. A history table 314 maintains a history of transactions to which a user has been a party. One or more attributes tables 316 record attribute information pertaining to items for which records exist within the items table 304. Considering only a single example of such an attribute, the attributes tables 316 can indicate a currency attribute associated with a particular item, with the currency attribute identifying the currency of a price for the relevant item as specified by a seller.

In some embodiments, the tables 300 can comprise data structures that can be loaded into memory or reside in memory. The memory can be updated or changed as the tables change.

### Keyword Bid Optimization

Users of keyword bidding, such as e-commerce websites (e.g., eBay.com®) and other online services, attract people to their sites by advertising on search engine websites (e.g., Google.com®, Bing.com®) using text ads. The mechanics of this text ads channel often requires such users to select a set of keywords, bid on those keywords, set up the appropriate creative and landing pages, and advertise to the right users, as well as perform other tasks. Optimal choices need to be made in all these dimensions (e.g., keyword selection, bidding, landing page) in order to profitably bring in the right set of people to the website. It can be difficult for a user to determine a bid for each keyword in the user's portfolio.

The term “user” can include a person, a group of people, an organization, or any other entity. The users of the keyword bid optimization features of the present disclosure can own, host, control, manage, or otherwise be associated with or acting on behalf of one or more online services provided on the applications server(s) 118 of FIGS. 1-2. For example, a user can be a seller or a manager of a listing on the networked system 102.

The issue of keyword bid optimization can be summarized using the following problem statement: given a set of keywords and a daily budget, determine how much a user is willing-to-pay (WTP) for each keyword. The willing-to-pay value is the “customer acquisition cost” that the user is willing to incur in pursuit of getting more revenue-generating users to its website. Given that search engine websites are running a generalized second price auction, which is close to being incentive-compatible in practice, one line of thinking can be that a bid should be equal to a user's willing-to-pay value. Given this thinking, the problem statement can be modified to the following: given a set of keywords and a daily budget, determine how much a user wants to bid for each keyword. The advantages of solving for the modified problem statement are: (1) in practice, the two problem statements are essentially equivalent; (2) an organization can see direct feedback of its bidding strategy using the search engine reports, and it is harder to build feedback loops off the user's willing-to-pay value; and (3) the user can use external data sources to guide its bids (e.g., Google® and Bing® API's can provide average cost-per-click (CPC) values for each keyword).

The problem statement can be even further modified to the following: given the set of keywords, determine how much revenue-per-click (RPC) the user can make for each keyword, and then bid that RPC amount on the search engine(s). Given the modified problem definition, an RPC prediction model can be built, and the bids can be sent to the search engine(s). However, there are problems with this approach.

One problem with this approach is that the user is essentially willing to work at zero margins when acquiring customers through this channel (e.g., the user is willing to give all the revenue it makes to the search engine). Another problem with this approach is that the model does not account for a daily (or some other periodic) budget of the user.

Yet another problem with this approach is that the model does not account for the CPC of the keywords. Hence, a high-revenue generating keyword will be assigned high bids, even if it has very high CPC, and can therefore result in not being profitable for the user.

Yet another problem with this approach is that revenue-generating events are very rare. Given the sparseness of the data, predicting RPC is an inherently difficult job. Hence, basing the bidding strategy on RPC prediction alone is very fragile.

Yet another problem with this approach is that it is solely focused on exploitation and does not involve exploration. For example, if a keyword starts out generating a poor RPC, the bid will be low. With a low bid, the chance of generating revenue becomes even harder, as a low bid results in fewer impressions (e.g., the number of appearances or views an advertisement receives), which results in fewer click-through events, and ultimately smaller revenue potential. Thus, a negative feedback cycle sets in for the keyword from which the model cannot recover. Even if low bid levels lead to a loss, high bid levels can generate a profit. As an example, if an organization were to bid $0.01 on the keyword “shoes”, it might get some impressions at 5 A.M. in the morning, which might be a time of the day with low revenue potential. However, a $0.20 bid might get some impressions during the evenings where the revenue potential (and profit) could be higher.

Yet another problem with this approach is that this model is a learner, not a revenue optimizer. The loss function (e.g., squared error, logistic error, log-likelihood) is the objective function of machine learning models, not RPC. The learner is trying to accurately predict RPC. It is not trying to optimize the bid in order to maximize the RPC. As an example, let's say the following are some of the features for a keyword: Search Volume (V)=1000; Impressions=10; Clicks=6; and RPC=$0.01. Let's say that this example is used to train an RPC (thereby bid) prediction model. Now, at prediction time, if a keyword has the features {V=1000; Imp=10; Clicks=6}, and the model is asked to predict RPC, a perfect learner should predict RPC=$0.01, and then the organization will go on to bid $0.01 for this keyword. On the other hand, if a revenue optimizer is given that same input, {V=1000; Imp=10; Clicks=6}, the optimizer might reason that the organization will do very well when it gets an impression (CTR=Click/Impressions=0.6). Hence, the organization should probably increase its bid and try to drive more impressions, particularly given that it wins only 10 impressions out of a total pool of 1000 volume. Therefore, an optimizer, which is not trying to be accurate, might decide on a bid=$0.03. Though it might not be the most accurate, it might be optimal.

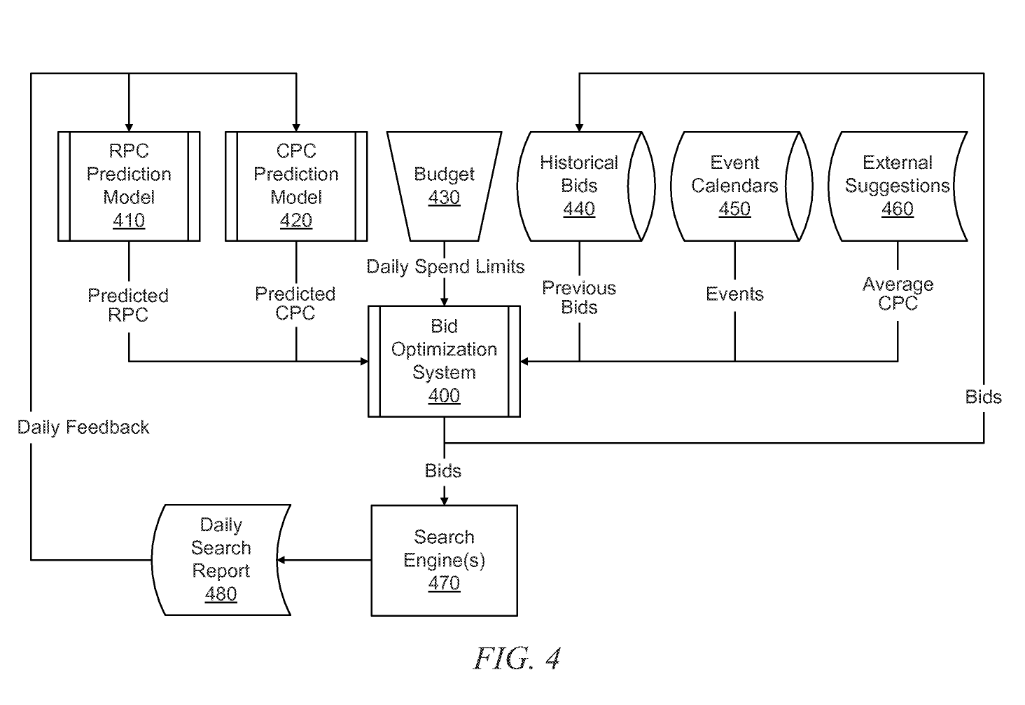

FIG. 4 is a block diagram illustrating interactions of a bid optimization system 400, in accordance with some embodiments. Bid optimization system 400 can comprise one or more modules, as will be discussed in further detail below. The bid optimization system 400 is configured to optimize keyword bids. In some embodiments, the bids are generated by an optimization routine, not a machine learned model, and one or more budget constraints of the user are factored into the optimization. The optimization algorithm can work as a budget allocation engine. In some embodiments, the bid optimization system 400 favors keywords that are making a profit (not just revenue), but also allows for exploration. The optimization algorithm employed by the bid optimization system 400 can scale to a large portfolio of keywords (e.g., hundreds of millions) that the user uses. This optimization is difficult to accomplish with a classical optimization formulation. However, the present disclosure provides techniques to achieve such optimization.

In some embodiments, for any keyword k in the user's portfolio, the bidₖ is generated by an optimization routine Opt( . . . ), which can depend on any combination of various parameters:

∀ₖ bidₖ=Opt(RPCₖ, CPCₖ, exposureMeasureₖ, historicalBidsₖ, eventCalendar, externalSuggestionₖ, dailyBudget, . . . )

Some of the parameters, such as the RPC and the CPC, can be learned by a machine learning based prediction model. In some embodiments, an RPC prediction model 410 can be used to supply the expected RPC for any keyword.

The parameter “exposureMeasure” can comprise a measure used to determine whether to increase a level of exposure for published content of the user, and it can be computed using one or more different data sets. For example, the exposure measure can comprise a ratio of the impressions that the user received with respect to the total search volume. The exposure measure can be based on information from search engine (or other third party) API's that provide a search volume for any given keyword. If it is determined that the number of impressions for a keyword is a predetermined degree smaller than what is typical for a certain population of the total search volume (e.g., the average number of impressions for the entire total search volume of a search engine over a specified period of time), the user might want to increase the corresponding bid to achieve more impressions for the keyword.

In another example of data being used for an exposure measure, it can be determined whether a CTR for a keyword is higher than a predetermined threshold relative to the total search volume population. Such an occurrence can be interpreted by the bid optimization system 400 to aim for more impressions for the user in an attempt to drive a larger number of clicks.

In another example, if it is determined that there is a predetermined amount of inventory volume on the user's site (e.g., an associated online marketplace) that has a predetermined level of affinity to a keyword, then the bid optimization system 400 can attempt to obtain more impressions for the keyword in order to drive more clicks and conversions.

In yet another example, a determined variation in a daily budget of a user can inform the bid optimization system 400 of an exposure appetite of a user for a keyword. For example, if the user has increased a daily budget by at least a certain degree or amount within a predetermined period of time for a portfolio of keywords that has remained the same or within a predetermined degree of similarity (e.g., at least 95% of the keywords in the portfolio have remained the same from the time the daily budget was increased), then the bid optimization system 400 can interpret such an occurrence as an indication that the user wants to increase the exposure level of the keywords in the user's portfolio.

The parameter “historical Bids” can comprise previous bids of the user for the same keyword(s). The previous bids can comprise the most recent bid for a keyword or a moving average of recent bids for a keyword.

The parameter “eventCalendar” can comprise indications of events associated with a desired increase in exposure. For example, an indication of a particular holiday, such as Christmas, can be used by the bid optimization system 400 to increase a bid for a keyword having an association with that holiday, in order to increase its exposure and take advantage of the event.

The parameter “externalSuggestion” can comprise externally suggested bids. For example API's of search engines or other third parties can provide information on what the average CPC is for any keyword.

Referring back to FIG. 4, the bid optimization system 400 can use any combination of the above-mentioned parameters to determine optimal bids for keywords. A predicted RPC and a predicted CPC can be determined using an RPC prediction model 410 and a CPC prediction model 420, respectively. The predicted RPC and the predicted CPC can be determined using daily or other period-based feedback about the performance results of the corresponding keyword on one or more search engines 470. This feedback can be provided by the search engine(s) 470 in the form of one or more daily or other period-based search reports 480. In some embodiments, the RPC prediction model 410 and the CPC prediction model 420 can be a part of or otherwise incorporated into the bid optimization system 400. In some embodiments, the RPC prediction model 410 and the CPC prediction model 420 can be implemented as their own modules, distinct from the bid optimization system 400.

Budget information 430 can be used by the bid optimization system 400 in determining the optimal bids for keywords. This budget information 430 can comprise daily or other period-based spend limits. The budget information 430 can be stored on and retrieved from one or more databases.

Historical bid information about previous bids can be stored on and retrieved from one or more historical bid database(s) 440. In some embodiments, the historical bid information includes, but is not limited to, the last bid (e.g., yesterday's bid) for each keyword being processed. This information about previous bids can be supplied to the historical bid database(s) 440 by the bid optimization system 400 after it determines the bids to output to the search engine(s) 470. The historical bid information can be used by the bid optimization system 400 in its determination of optimal bids for keywords.

Event calendar information about future events can be stored on and retrieved from one or more event calendar database(s) 450. In some embodiments, the event calendar information includes, but is not limited to, information about future events that could influence the effectiveness, and therefore value, of a keyword. Examples of such future events include, but are not limited to, holidays (e.g., certain keywords can be more effective around Christmas time) and product launch events (e.g., certain keywords can be more effective around the time that a new version of a smartphone is released). The event calendar information can be used by the bid optimization system 400 in its determination of optimal bids for keywords.

External suggestions 460 can also be used by the bid optimization system 400 in its determination of optimal bids for keywords. Such external suggestions 460 can include, but are not limited to, user-suggested bids for keywords, which can be based on average CPC's for the keywords.

When the bid optimization system 400 determines bids for keywords, these determined bids can then be provided to the one or more search engines 470 for use by the search engines 470 in determining prioritization of sponsored search results for the corresponding keywords, as well as to the historical bid database(s) 440 for use in subsequent determinations of optimal bids for the corresponding keywords.

In some embodiments, the optimization routine Opt( . . . ) is implemented as an iterative, greedy algorithm that takes advantage of feedback cycles extensively. The tight feedback loop helps achieve a close-to-optimal bidding strategy and allows the system to employ a greedy algorithm technique to make a locally optimal choice for each keyword in updating the bid value for each keyword, as the feedback loop enables immediate course correction of bid value updates resulting from a greedy algorithm technique. This system design also enables bid optimization at a high scale where the user has hundreds of millions of keywords in a portfolio.

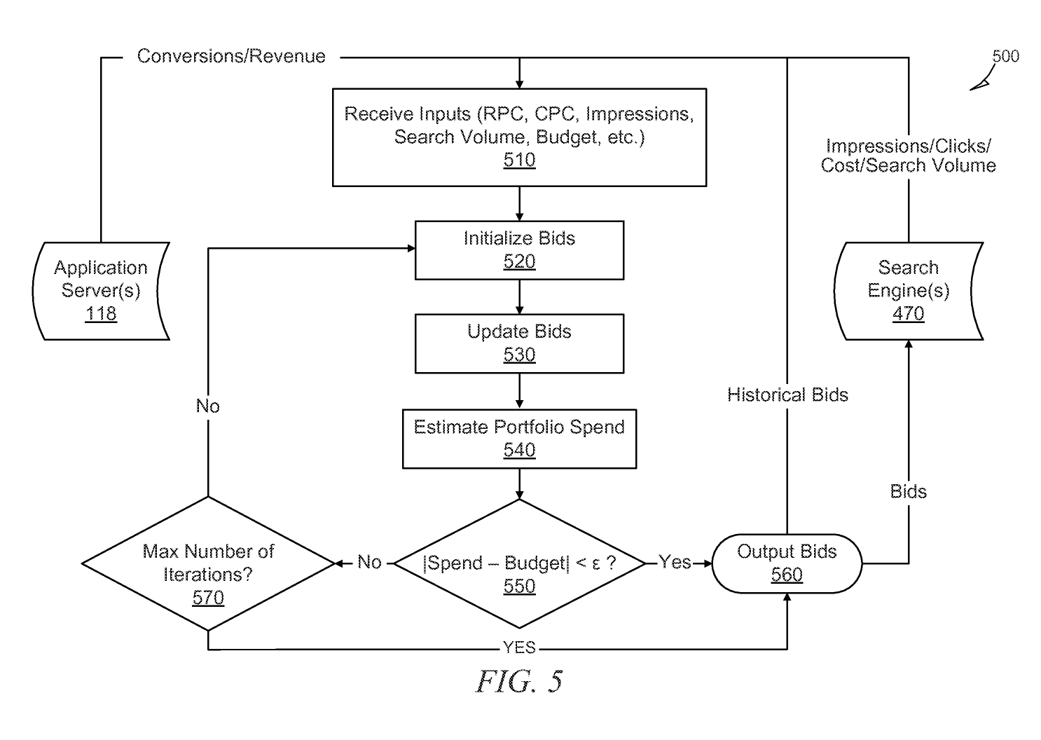

FIG. 5 is a flowchart illustrating a method 500 of optimizing keyword bids, in accordance with some embodiments. The operations of method 500 can be performed by a system or modules of a system (e.g., bid optimization system 400 or any of its modules). In some embodiments, the method 500 (e.g., optimization algorithm Opt( . . . )) is implemented as an iterative algorithm.

At operation 510, inputs can be received. These inputs can comprise information regarding the keywords being processed. Such information can include, but is not limited to, RPC resulting from keywords. CPC resulting from keywords, impressions resulting from keywords, as well as any of the other parameters discussed herein. The inputs can also comprise search volume information and budget information. These inputs can be supplied and/or retrieved from a variety of sources, including, but not limited to, the organization (e.g., an e-commerce website) on whose behalf the bids are being determined and submitted, as well as the one or more search engines to which the keyword bids are submitted.

At operation 520, the corresponding bid for each keyword can be initialized to a reasonable value. In some embodiments, this initialized bid value can be equal to or otherwise based on a value supplied by a user. In some embodiments, this initialized bid value can be equal to or otherwise based on a historical bid (e.g., yesterday's determined bid for the same keyword). In some embodiments, this initialized bid value can be equal to or otherwise based on the bid value previously determined in the last iteration of the greedy algorithm disclosed herein.

At operation 530, the initialized bid value for each keyword can be updated (e.g., increased or decreased). In some embodiments, this updating of the bid value is based on one or more greedy-algorithm-based rules.

At operation 540, a spend estimate of the portfolio of keywords can be calculated. In some embodiments, this calculation is based on the corresponding updated values of the keywords.

At operation 550, the estimated portfolio spend can be compared against the daily or other period-based budget. If the spend is close to the budget (e.g., the difference is less than a predetermined amount), then the optimization algorithm Opt( . . . ) has been determined to have converged, and the newly-determined bids for the corresponding keywords can be output at operation 560. These newly-determined bids can be provided to one or more search engines. These newly determined bids can also be fed back into the optimization algorithm at operation 510 for subsequent use in optimizing the keyword bids.

If it is determined, at operation 550, that the portfolio spend does not converge to the budget, then it can then be determined, at operation 570, whether a maximum threshold number of iterations of the optimization algorithm has been reached. If the maximum threshold of iterations has not been reached, then the method 500 can return back to operation 520, where the bid values for the corresponding keywords are initialized, thereby implementing a tight feedback loop for updating the bid values again. If the maximum threshold of iterations has been reached, then the newly-determined bids for the corresponding keywords can be output at operation 560.

It is contemplated that the operations of method 500 can incorporate any of the other features disclosed herein.

In some embodiments, each execution of the optimization algorithm Opt( . . . ) can be scheduled once every day. The duration can be gated by an engineering maturity of the user. However, other schedules of execution are also within the scope of the present disclosure. In some embodiments, every day (or other period) when the optimization algorithm Opt( . . . ) runs, it takes as input the feedback (RPC, CPC, impression counts, click counts etc.) of the actions (bids) it took the run before, thereby enabling the optimization algorithm Opt( . . . ) to course-correct quickly and reach its goal of achieving optimality in terms of the objective functions.

One example embodiment of the optimization algorithm Opt( . . . ) is provided below:

```
Opt( .... )
      totalSpend = 0, iteration_count = 0
      Loop until totalSpend = (budget ± ε) or iteration_count >
      threshold
            Iteration_count = iteration_count + 1
            bid initialization-
                  if user override is available
                      bid = user override
                      break
                  else If bid from previous iteration is available
                      bid = previous iteration bid
                  else if user suggested bid is available
                      bid = user suggested bid
                  else if historical bid is available
                      bid = historical bid
                  else
                      bid = default bid
            bid update -
                  if predictedRPC > predictedCPC
                      increase bid
                  else
                      decrease bid
                  if exposure < population-central-tendency
                      increase bid
                  bid = α bid + (1 − α) externalSuggestion
                  α ∈ [0, 1]
                  bid = min (max_bid, max (min_bid, bid))
            Spend Estimation -
                  totalSpend = 0
                  Loop for every keyword k,
                      Spendₖ = CPCₖ * Clickₖ
                      totalSpend += Spendₖ
```

The optimization algorithm Opt( . . . ) above is allocating the budget using two objective functions—it is allocating more funds (by raising the bids) to the profit-making keywords, and it is also allocating funds where more exposure or exploration is required or desired. These bid update functions represent greedy algorithm techniques, as they make a locally optimal choice for each keyword in updating the bid value for each keyword. In some embodiments, the exposure/exploration function can also have some randomization component to it. For example, the optimization algorithm can randomly choose to bid high (e.g., a random bid value) for certain keywords in order to collect performance information (e.g., impression data, click data, revenue data), which can be particularly useful for keywords that do not have sufficient historical data available.

It is noted that the algorithm is also able to bias one objective function compared to the other. For example, if the increase in bid is more aggressive in case of profit as compared to the bid increase in case of exploration requirements, then that would imply that the algorithm “favors” profit over exploration. The bid optimization system 400 can be configured to enable the user to configure the degrees or amounts of the different increases for the profit-based increase and the exposure-based increase. For example, the bid optimization system 400 can provide a user interface that can be accessed and used by the user to adjust the respective increase amounts.

The objective functions (maximize profit and maximize exposure) can be optimized subject to soft and hard constraints. The daily budget, a user override, a minimum bid value (min_bid), and a maximum bid value (max_bid) can be used as hard constraints, while user suggested bids and external suggestions can be used as soft constraints to guide the optimization.

In some embodiments, a hard constraint that does not allow the optimization to change the bid of a particular keyword more than some percentage relative to its last-run-bid (which can work like the circuit breakers in the stock market) can be incorporated into the optimization algorithm Opt( . . . ).

It is noted that the spend estimation for a keyword is non-trivial. The CPC and the click count that can be seen by the user the next day can be dependent upon the bid the user decides on in the current run of the optimization. It is possible to build regression models for CPC and clicks given the bid. In some embodiments, some shortcuts for the regression models can be employed. Let's say we want to compute the Spend_{k,t1} [spend for keyword k for time t1]—

Spend_{k,t1}=CPC_{k,t1}*Click_{k,t1} (1)

CPC_{k,t1} can be the CPC for keyword k for time t1, and Click_{k,t1} can be the click count for keyword k for time t1. Since the bid is an upper bound for the CPC, we overestimate the spend as

Spend_{k,t1}≦bid_{k,t1}*Click_{k,t1} (2)

Since we are overestimating the Spend, we can choose to increase our daily budget with a fudge factor.

In embodiments where we do not have a click prediction model given the bid, we do not know what Click_{k,t1} is. However, since we have used circuit breakers as a constraint in the optimization, we know that the bids would not drastically change every day. Hence, we assume yesterday's click count will be similar to tomorrow's click count, i.e.,

Click_{k,t1}≈Click_{k,t0} where t0<t1

Hence, we have an approximate spend estimation:

Spend_{k,t1}≈bid_{k,t1}*Click_{k,t0} (3)

We can use equation (3) above to estimate the Spend.

It is noted that the bids can be updated using greedy rules. Though, in theory, it is possible to learn the elasticity of profit with respect to the bids (e.g., the measurement of how responsive profit is to a change in a bid or bids), in practice it is non-trivial to build such elasticity models. Hence, the optimization algorithm of the present disclosure can rely on tight feedback loops instead of trying to build such complex elasticity models.

In some embodiments, this optimization algorithm always tries to spend the budget, which can be an explicit business goal. In case there is excess budget (e.g., bids have been raised for all the profitable cases and the low exposure cases, right up to the upper-limit of the circuit breakers), then what profit means can be redefined. For example, if there is a lot of money to spend, then good-profitable-cases can be defined to be a return-on-investment (ROI) of greater than −15%, and the algorithm will seamlessly adapt given a configuration change.

In a typical maximization problem, the objective function is concave in order to facilitate greedy solutions. Interestingly, in the optimization technique of the present disclosure, the update rule can assume a convex dependency between the bid and the profit, such that as a bid increases, the profit does not decrease. Profitability can still be maintained given the bid updates during the loop (e.g., in three iterations of the loop, the bid can be increased three times).

In some embodiments, this assumption is clearly too simplistic. However, this algorithmic challenge can be resolved using a system design of feedback loops. In one example, on a first day, the algorithm increases a bid for a keyword based on a detected profit. Subsequent to, and as a result of the increased bid, the keyword is associated with a loss. On the second day, the algorithm would detect the loss, and then scale back the bid to go back to the profitable zone. In general, this algorithm will have the property of oscillating between profit and loss zones. Hence, if the budget were not a constraint (we had excess budget), the algorithm could push each keyword to spend the maximum amount it can while being revenue neutral. If the budget were set at appropriate levels, this algorithm could operate in the profitable zones only.

In some embodiments, the algorithm and the system design together achieve an optimal solution for this optimization problem. The closer to real-time the bid updates become, the closer to optimality the system reaches.

The tight feedback loop greatly reduces the impact of imperfect model predictions as well, which is a significant gain since RPC and CPC predictions are expected to be very noisy given the sparseness of their data sets. The algorithm and system design of the present disclosure greatly reduces the burden of accuracy from these supporting models and improves the robustness of a user's bidding strategy.

Additionally, in some embodiments, the optimization algorithm disclosed herein is reasonably parallelizable, as well as distributable, since the loop can operate per keyword, with the portfolio level budget check being the only synchronization point. In some embodiments, an iterative map-reduce implementation of the optimization algorithm can be run on a cluster, and can be scaled to hundreds of millions and even several billions of keywords. Such an implementation can complete its daily execution within a few hours, which can be critical in embodiments where a tight feedback loop is desired. The closer to real-time it is, the better the optimization.

The modular nature of the overall system (optimization algorithm, RPC model, CPC model) leads to several gains. The first advantage is engineering agility. The second and more subtle advantage is that the success metric can be rationalized. For example, in some embodiments, only the optimization algorithm is responsible for driving the revenue and profit metrics, since it is the one making the tradeoff decisions. The other models, such as the RPC and CPC models, can strive for accuracy only.

This algorithm is capable of accepting human help at various stages. For example, it can accept overrides, suggestions, caps and limits, thereby enabling the users to intervene when the algorithm fails to make the right choices.

Using a combination of system design and algorithmic techniques, the optimization algorithm disclosed herein helps determine bids for the keywords that a user uses on search engines. The techniques disclosed herein can employ various disciplines, such as machine learning, convex optimization, and control theory.

The optimization algorithm can scale to the data sizes that a user's products need to work with. It can make simplifying assumptions to improve the scalability of the algorithm and reduce code complexity. It can also use system design techniques (e.g., feedback loops) to cover for the assumptions it makes.

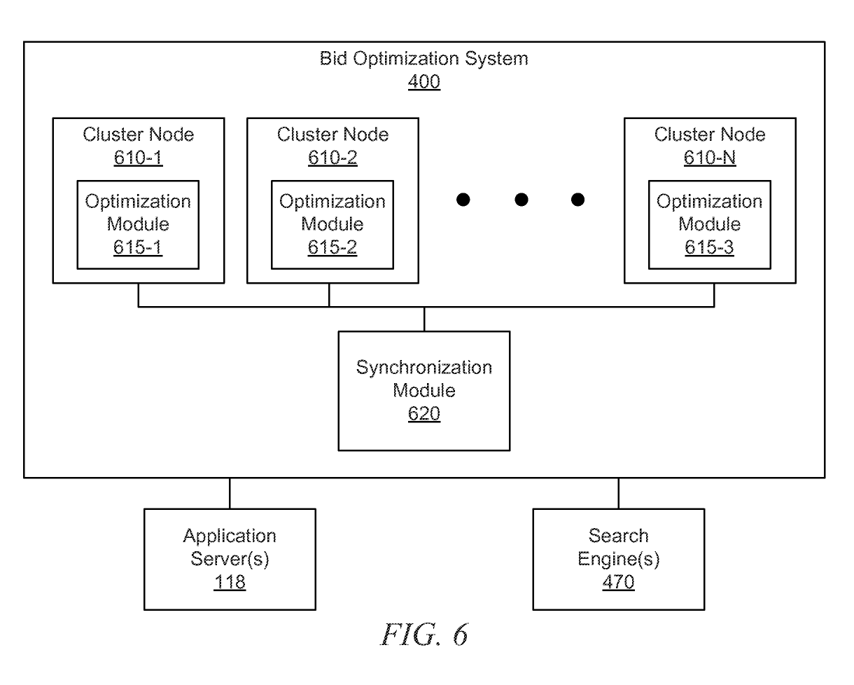

FIG. 6 is a block diagram illustrating components of the bid optimization system 400, in accordance with some embodiments. As previously discussed, certain operations or functions (e.g., bid initialization, bid update, spend estimation) of the optimization algorithm can be performed in parallel by a cluster of nodes, with each node performing the operations or functions for a corresponding keyword of the user's portfolio of keywords. Accordingly, bid optimization system 400 can comprise a plurality of cluster nodes 610-1 to 610-N (collectively 610). The cluster nodes 610 can comprise physical machines or virtual machines. Each one of the cluster nodes 610 can comprise its own instance of an optimization module 610 (e.g., optimizations modules 615-1, 615-2, . . . , 615-N) configured to perform the optimization algorithm of the present disclosure for its corresponding keyword.

Bid optimization system 400 can also comprise a synchronization module 620 configured to synchronize the operations of the optimization modules 615, as well as data resulting from the operations of the optimization modules 615. For example, after each iteration of the loop in the optimization algorithm, the synchronization module 620 can be configured to calculate the total spend for the keyword portfolio based on the most recent update of the bid values for the keywords in the portfolio. The synchronization module 620 can be configured to determine whether the total spend has reached or come within a predetermined amount of the user's specified budget, and then end the loop based on a determination that the total spend reached such a value. The synchronization module 620 can also be configured to end the loop in the optimization algorithm based on a determination that an iteration count for the loop has reached a threshold value.

The bid optimization system 400 can be communicatively coupled to the application server(s) 118 in order to receive data from an online service of the user. For example, the bid optimization system 400 can be configured to obtain inventory information, event information, revenue information, conversion information, RPC information, CPC information, and CTR information of an online marketplace of the user from the application server(s) 118. The information obtained from the application server(s) 118 can then be used by the optimization algorithm of the optimization modules 615.

The bid optimization system 400 can also be communicatively coupled to the search engine(s) 470 in order to receive information (e.g., impressions, clicks, cost, search volume) from the search engine(s) 470, which can then be used by the optimization algorithm of the optimization modules 615. Furthermore, the bid optimization system 400 can be configured to transmit the updated bids for the keywords in the user's keyword portfolio to the search engine(s) 470.

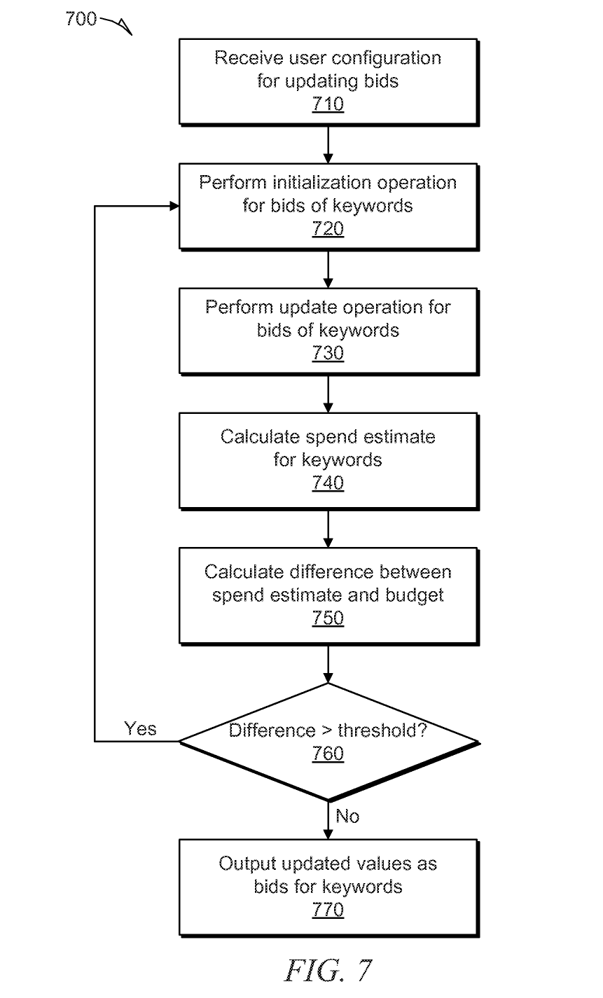

FIG. 7 is a flowchart illustrating a method 700 of optimizing keyword bids, in accordance with some embodiments. The method 700 can be performed by processing logic that can comprise hardware (e.g., circuitry, dedicated logic, programmable logic, microcode, etc.), software (e.g., instructions run on a processing device), or a combination thereof. In one implementation, the method 700 is performed by the modules (e.g., optimization modules 615 and synchronization module 620) of bid optimization system 400.

At operation 710, a user configuration for updating bids can be received from a user, such as via a user interface presented to the user on a computing device. The user can set or adjust values for updating bids for keywords in the user's keyword portfolio. The user can set different values for updating a bid based on a profit determination than for updating a bid based on an exposure determination, as previously discussed. The user can also set the degree to which external suggestions will affect the bids.

At operation 720, for each keyword in the user's portfolio of keywords, an initialization operation can be performed to initialize a corresponding bid for the keyword at a corresponding initialization value using a cluster of nodes. Each node in the cluster of nodes can correspond to a different keyword in the plurality of keywords. The corresponding bids for the keywords can be initialized in parallel by the cluster of nodes.

At operation 730, for each keyword in the user's keyword portfolio, an update operation can be performed to update the corresponding bid for the keyword to a corresponding updated value different from the corresponding initialization value using the cluster of nodes. The bids can be updated based on at least one greedy algorithm rule. The corresponding bids can be updated in parallel by the cluster of nodes.

In some embodiments, the update operation can comprise increasing the corresponding bid for a keyword by a first value based on a profit determination for the keyword. The profit determination can comprise a determination that the keyword meets a predetermined threshold of profitability. The update operation can also comprise increasing the corresponding bid for the keyword by a second value based on an exposure determination for the keyword. The exposure determination can comprise a determination to increase a level of exposure for published content of the user. The level of exposure can correspond to searches of the keyword on a search engine. The first value and second value can be based on the user configuration at operation 710.

In some embodiments, the exposure determination can be based on a determination that a ratio of a number of impressions for the published content on the search engine to a total search volume on the search engine for a specified period of time is less than a predetermined value. The exposure determination can be based on a determination that a click-through rate for the keyword on the search engine is a predetermined amount greater than a click-through rate for a population of keywords on the search engine. The exposure determination can be based on a determination that a predetermined amount of inventory on an online marketplace of the user has a predetermined level of affinity with the keyword. The exposure determination can be based on a determination that a period-based budget of the user has increased by at least a predetermined amount.

In some embodiments, the update operation can comprise adjusting the corresponding bid for a keyword based on an external suggestion from an API of a search engine.

At operation 740, a spend estimate calculation operation can be performed to calculate a spend estimate of the keywords in the keyword portfolio based on the corresponding updated values of the keywords. At operation 750, a difference calculation operation can be performed to calculate a difference between the calculated spend estimate and a predetermined budget.

At operation 760, it can be determined whether the difference between the calculated spend estimate and the predetermined budget is greater than a predetermined threshold. Based on a determination that the difference is greater than the predetermined threshold, the method 700 can return to the initialization operation 720, thereby implementing a tight feedback loop. Based on a determination that the difference is not greater than the predetermined threshold, the most recent updated values for the keywords can be used as output at operation 770, such as by transmitting the updated values as bids for their corresponding keywords to one or more search engines.

It is contemplated that any of the other features described within the present disclosure can be incorporated into the method 700.

### Modules, Components and Logic

Certain embodiments are described herein as including logic or a number of components, modules, or mechanisms. Modules can constitute either software modules (e.g., code embodied on a machine-readable medium or in a transmission signal) or hardware modules. A hardware module is a tangible unit capable of performing certain operations and can be configured or arranged in a certain manner. In example embodiments, one or more computer systems (e.g., a standalone, client, or server computer system) or one or more hardware modules of a computer system (e.g., a processor or a group of processors) can be configured by software (e.g., an application or application portion) as a hardware module that operates to perform certain operations as described herein.

In various embodiments, a hardware module can be implemented mechanically or electronically. For example, a hardware module can comprise dedicated circuitry or logic that is permanently configured (e.g., as a special-purpose processor, such as a field programmable gate array (FPGA) or an application-specific integrated circuit (ASIC)) to perform certain operations. A hardware module can also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) can be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor can be configured as respective different hardware modules at different times. Software can accordingly configure a processor, for example, to constitute a particular hardware module at one instance of time and to constitute a different hardware module at a different instance of time.

Hardware modules can provide information to, and receive information from, other hardware modules. Accordingly, the described hardware modules can be regarded as being communicatively coupled. Where multiple of such hardware modules exist contemporaneously, communications can be achieved through signal transmission (e.g., over appropriate circuits and buses) that connect the hardware modules. In embodiments in which multiple hardware modules are configured or instantiated at different times, communications between such hardware modules can be achieved, for example, through the storage and retrieval of information in memory structures to which the multiple hardware modules have access. For example, one hardware module can perform an operation and store the output of that operation in a memory device to which it is communicatively coupled. A further hardware module can then, at a later time, access the memory device to retrieve and process the stored output. Hardware modules can also initiate communications with input or output devices and can operate on a resource (e.g., a collection of information).

The various operations of example methods described herein can be performed, at least partially, by one or more processors that are temporarily configured (e.g., by software) or permanently configured to perform the relevant operations. Whether temporarily or permanently configured, such processors can constitute processor-implemented modules that operate to perform one or more operations or functions. The modules referred to herein can, in some example embodiments, comprise processor-implemented modules.

Similarly, the methods described herein can be at least partially processor-implemented. For example, at least some of the operations of a method can be performed by one or more processors or processor-implemented modules. The performance of certain of the operations can be distributed among the one or more processors, not only residing within a single machine, but deployed across a number of machines. In some example embodiments, the processor or processors can be located in a single location (e.g., within a home environment, an office environment or as a server farm), while in other embodiments the processors can be distributed across a number of locations.

The one or more processors can also operate to support performance of the relevant operations in a “cloud computing” environment or as a “software as a service” (SaaS). For example, at least some of the operations can be performed by a group of computers (as examples of machines including processors), these operations being accessible via a network (e.g., the network 104 of FIG. 1) and via one or more appropriate interfaces (e.g., APIs).

### Electronic Apparatus and System

Example embodiments can be implemented in digital electronic circuitry, or in computer hardware, firmware, software, or in combinations of them. Example embodiments can be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations can be performed by one or more programmable processors executing a computer program to perform functions by operating on input data and generating output. Method operations can also be performed by, and apparatus of example embodiments can be implemented as, special purpose logic circuitry (e.g., a FPGA or an ASIC).

A computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware can be a design choice. Below are set out hardware (e.g., machine) and software architectures that can be deployed, in various example embodiments.

### Example Machine Architecture and Machine-Readable Medium

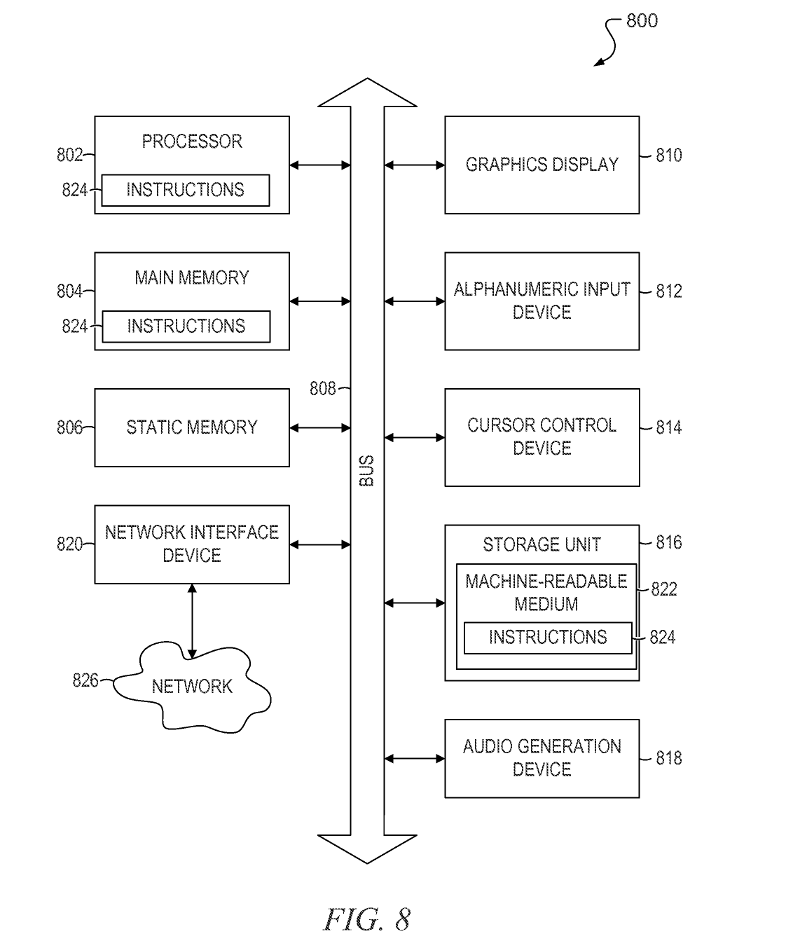

FIG. 8 is a block diagram of a machine in the example form of a computer system 800 within which instructions for causing the machine to perform any one or more of the methodologies discussed herein can be executed. In alternative embodiments, the machine operates as a standalone device or can be connected (e.g., networked) to other machines. In a networked deployment, the machine can operate in the capacity of a server or a client machine in a server-client network environment, or as a peer machine in a peer-to-peer (or distributed) network environment. The machine can be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes a processor 802 (e.g., a central processing unit (CPU), a graphics processing unit (GPU) or both), a main memory 804 and a static memory 806, which communicate with each other via a bus 808. The computer system 800 can further include a video display unit 810 (e.g., a liquid crystal display (LCD) or a cathode ray tube (CRT)). The computer system 800 also includes an alphanumeric input device 812 (e.g., a keyboard), a user interface (UI) navigation (or cursor control) device 814 (e.g., a mouse), a disk drive unit 816, a signal generation device 818 (e.g., a speaker), and a network interface device 820.

### Machine-Readable Medium

The disk drive unit 816 includes a machine-readable medium 822 on which is stored one or more sets of data structures and instructions 824 (e.g., software) embodying or utilized by any one or more of the methodologies or functions described herein. The instructions 824 can also reside, completely or at least partially, within the main memory 804 and/or within the processor 802 during execution thereof by the computer system 800, the main memory 804 and the processor 802 also constituting machine-readable media. The instructions 824 can also reside, completely or at least partially, within the static memory 806.

While the machine-readable medium 822 is shown in an example embodiment to be a single medium, the term “machine-readable medium” can include a single medium or multiple media (e.g., a centralized or distributed database, and/or associated caches and servers) that store the one or more instructions 824 or data structures. The term “machine-readable medium” shall also be taken to include any tangible medium that is capable of storing, encoding or carrying instructions for execution by the machine and that cause the machine to perform any one or more of the methodologies of the present embodiments, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and compact disc-read-only memory (CD-ROM) and digital versatile disc (or digital video disc) read-only memory (DVD-ROM) disks.

### Transmission Medium

The instructions 824 can further be transmitted or received over a communications network 826 using a transmission medium. The instructions 824 can be transmitted using the network interface device 820 and any one of a number of well-known transfer protocols (e.g., HTTP). Examples of communication networks include a LAN, a WAN, the Internet, mobile telephone networks, POTS networks, and wireless data networks (e.g., WiFi and WiMax networks). The term “transmission medium” shall be taken to include any intangible medium capable of storing, encoding, or carrying instructions for execution by the machine, and includes digital or analog communications signals or other intangible media to facilitate communication of such software.

Although an embodiment has been described with reference to specific example embodiments, it will be evident that various modifications and changes can be made to these embodiments without departing from the broader spirit and scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter can be practiced. The embodiments illustrated are described in sufficient detail to enable those skilled in the art to practice the teachings disclosed herein. Other embodiments can be utilized and derived therefrom, such that structural and logical substitutions and changes can be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter can be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose can be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A system comprising:
a machine having at least one module, the at least one module comprising at least one processor and being configured to:
perform an initialization operation, for each keyword in a plurality of keywords associated with a user, to initialize a corresponding bid for the keyword at a corresponding initialization value using a cluster of nodes, each node in the cluster of nodes corresponding to a different keyword in the plurality of keywords, the corresponding bids for the keywords being initialized in parallel by the cluster of nodes;
perform an update operation, for each keyword in the plurality of keywords, to update the corresponding bid for the keyword to a corresponding updated value different from the corresponding initialization value using the cluster of nodes, the corresponding bids being updated in parallel by the cluster of nodes;
perform a spend estimate calculation operation to calculate a spend estimate of the plurality of keywords based on the corresponding updated values of the keywords;
perform a difference calculation operation to calculate a difference between the calculated spend estimate and a predetermined budget; and
based on a determination that the difference between the calculated spend estimate and the predetermined budget is greater than a predetermined threshold, repeat the initialization operation, the update operation, the spend estimate calculation operation, and the difference calculation operation.

2. The system of claim 1, wherein the at least one module is further configured to transmit the updated values to at least one search engine as bids for their corresponding keywords based on a determination that the difference between the calculated spend estimate and a predetermined budget is less than a predetermined threshold.

3. The system of claim 1, wherein the update operation comprises:
increasing the corresponding bid for at least one keyword of the plurality of keywords by a first value based on a profit determination for the at least one keyword, the profit determination comprising a determination that the at least one keyword meets a predetermined threshold of profitability; and
increasing the corresponding bid for the at least one keyword by a second value based on an exposure determination for the at least one keyword, the exposure determination comprising a determination to increase a level of exposure for published content of the user, the level of exposure corresponding to searches of the at least one keyword on a search engine.

4. The system of claim 3, wherein the at least one module is further configured to enable the user to configure the first value and the second value.

5. The system of claim 3, wherein the exposure determination is based on a determination that a ratio of a number of impressions for the published content on the search engine to a total search volume on the search engine for a specified period of time is less than a predetermined value.

6. The system of claim 3, wherein the exposure determination is based on a determination that a click-through rate for the at least one keyword on the search engine is a predetermined amount greater than a click-through rate for a population of keywords on the search engine.

7. The system of claim 3, wherein the exposure determination is based on a determination that a predetermined amount of inventory on an online marketplace of the user has a predetermined level of affinity with the at least one keyword.

8. The system of claim 3, wherein the exposure determination is based on a determination that a period-based budget of the user has increased by at least a predetermined amount.

9. The system of claim 1, wherein the update operation comprises adjusting the corresponding bid for at least one keyword of the plurality of keywords based on an external suggestion from an application programming interface (API) of a search engine.

10. A computer-implemented method comprising:
enabling, by a machine having a memory and at least one processor, a user to configure a first value and a second value;
performing an initialization operation, for each keyword in a plurality of keywords associated with the user, to initialize a corresponding bid for the keyword at a corresponding initialization value using a cluster of nodes, each node in the cluster of nodes corresponding to a different keyword in the plurality of keywords, the corresponding bids for the keywords being initialized in parallel by the cluster of nodes; and
performing an update operation, for each keyword in the plurality of keywords, to update the corresponding bid for the keyword to a corresponding updated value different from the corresponding initialization value using the cluster of nodes, the corresponding bids being updated in parallel by the cluster of nodes, the update operation comprising:
increasing the corresponding bid for at least one keyword of the plurality of keywords by a first value based on a profit determination for the at least one keyword, the profit determination comprising a determination that the at least one keyword meets a predetermined threshold of profitability; and
increasing the corresponding bid for the at least one keyword by a second value based on an exposure determination for the at least one keyword, the exposure determination comprising a determination to increase a level of exposure for published content of the user, the level of exposure corresponding to searches of the at least one keyword on a search engine.

11. The method of claim 10, further comprising:
performing a spend estimate calculation operation to calculate a spend estimate of the plurality of keywords based on the corresponding updated values of the keywords; and
performing a difference calculation operation to calculate a difference between the calculated spend estimate and a predetermined budget.

12. The method of claim 11, further comprising repeating the initialization operation, the update operation, the spend estimate calculation operation, and the difference calculation operation based on a determination that the difference between the calculated spend estimate and the predetermined budget is greater than a predetermined threshold.

13. The method of claim 11, further comprising transmitting the updated values to at least one search engine as bids for their corresponding keywords based on a determination that the difference between the calculated spend estimate and a predetermined budget is less than a predetermined threshold.

14. The method of claim 10, wherein the exposure determination is based on a determination that a ratio of a number of impressions for the published content on the search engine to a total search volume on the search engine for a specified period of time is less than a predetermined value.

15. The method of claim 10, wherein the exposure determination is based on a determination that a click-through rate for the at least one keyword on the search engine is a predetermined amount greater than a click-through rate for a population of keywords on the search engine.

16. The method of claim 10, wherein the exposure determination is based on a determination that a predetermined amount of inventory on an online marketplace of the user has a predetermined level of affinity with the at least one keyword.

17. The method of claim 10, wherein the exposure determination is based on a determination that a period-based budget of the user has increased by at least a predetermined amount.

18. The method of claim 10, wherein the update operation comprises adjusting the corresponding bid for at least one keyword of the plurality of keywords based on an external suggestion from an application programming interface (API) of a search engine.

19. A non-transitory machine-readable storage device storing a set of instructions that, when executed by at least one processor, causes the at least one processor to perform operations comprising:
performing an initialization operation, for each keyword in a portfolio of keywords associated with a user, to initialize a corresponding bid for the keyword at a corresponding initialization value using a cluster of nodes, each node in the cluster of nodes corresponding to a different keyword in the portfolio of keywords, the corresponding bids for the keywords being initialized in parallel by the cluster of nodes;
performing an update operation, for each keyword in the portfolio of keywords, to update the corresponding bid for the keyword to a corresponding updated value different from the corresponding initialization value using the cluster of nodes, the corresponding bids being updated in parallel by the cluster of nodes;
performing a spend estimate calculation operation to calculate a spend estimate of the portfolio of keywords based on the corresponding updated values of the keywords;
performing a difference calculation operation to calculate a difference between the calculated spend estimate and a predetermined budget; and
based on a determination that the difference between the calculated spend estimate and the predetermined budget is greater than a predetermined threshold, repeating the initialization operation, the update operation, the spend estimate calculation operation, and the difference calculation operation.

20. The device of claim 19, wherein the operations further comprise, based on a determination that the difference between the calculated spend estimate and a predetermined budget is less than a predetermined threshold, transmitting the updated values to at least one search engine as bids for their corresponding keywords.
